(19) United States
(12) Patent Application Publication
(10) Pub. No.: US 2006/0190174 A1
(43) Pub. Date: Aug. 24, 2006

(54) Electronic compass and direction finding method

(75) Inventors: Xueping Li, Tokai-shi (JP); Hitoshi Aoyama, Tokai-shi (JP); Yoshinobu Honkura, Tokai-shi (JP); Eiji Kako, Tokai-shi (JP); Katsuhiko Tsuchida, Tokai-shi (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: AICHI MICRO INTELLIGENT CORPORATION, Tokai-shi (JP)

(21) Appl. No.: 11/359,574

(22) Filed: Feb. 23, 2006

(30) Foreign Application Priority Data
Feb. 24, 2005 (JP) 2005-049731

(51) Int. Cl. G01C 17/38

(52) U.S. Cl. 701/224; 33/356

(57) ABSTRACT

An electronic compass and direction finding method includes a geomagnetic direction sensor having two sensor elements for detecting perpendicular components of the Earth's magnetic field vector. A microcomputer is coupled to the geomagnetic direction sensor to compute a heading of a vehicle in software. Even if the electronic compass displays directional errors due to magnetization of the vehicle, a center of an azimuth circle can be immediately corrected by a center calculating means and a relatively accurate heading can be displayed. Later, the center of the azimuth circle can be corrected with a higher accuracy by a least squares calculating means. This frees a vehicle driver from uneasiness due to display of an intelligible direction.

### BACKGROUND OF THE INVENTION

This invention relates to an electronic compass and a direction finding method of a mobile object, using a magnetic sensor and, more particularly, to an electronic compass and a direction finding method for calibrating directional errors caused by disturbing magnetic fields, for example, generated by magnetization of the mobile object.

First, a direction finding principle using a conventional magnetic sensor will be explained with reference to FIG. 1. The conventional geomagnetic direction sensor has a ring-shaped permalloy core 51, on which an exciting coil L₀ is wound. A pair of coils Lₓ, L_{y} perpendicular to each other are also wound on the core 51. An excitation power source 52 supplies an alternating current to the exciting coil Lₒ so that the permalloy core 51 is magnetically saturated. Owing to this magnetic excitation, in this figure, at the uppermost point where the coil Lₓ crosses the core 51, a magnetic flux Φ₁) is interlinked, while at the lowermost point, a magnetic flux Φ₂ is interlinked. Since the magnetic fluxes Φ₁ and Φ₂ have an equal density but opposite directions, the total magnetic flux interlinked with the entire coil Lₓ is zero. The same applies to the coil L_{y}. Accordingly, an output X of the coil Lₓ and an output Y of the coil L_{y} are X=0 and Y=0, respectively.

As illustrated in FIG. 1, when a lateral horizontal magnetic field He is applied, a certain magnetic flux Φ₀, which passes through the permalloy core 51 in the right direction in the drawing, is given as a bias. So, the linkage flux at the uppermost of the coil Lₓ is (Φ₀+Φ₁), while the linkage flux at the lowermost of the coil Lₓ is (Φ₀−Φ₂). Accordingly, the total magnetic linkage flux of the coil Lₓ is not zero and the output X of the coil Lₓ has a certain value. On the other hand, since the aforementioned magnetic flux Φ₀ does not cross the coil L_{y}, the output Y of the coil L_{y} is zero. Next, when the Earth's magnetic field He′ is applied at an angle of Ψ to the coil Lₓ, two components Hₒₓ and H_{oy} of the Earth's magnetic field vector He′acting on the coils Lₓ, L_{y} are obtained by the following equations:
Hₒₓ=He′ cos Ψ
H_{oy}=He′ sin Ψ [Equations 1]

The outputs X, Y have certain values in accordance with these two components of the Earth's magnetic field vector. As apparent from the above Equations 1, as the angle Ψ is varied, namely, the mobile object on which the geomagnetic direction sensor is mounted is turned, the outputs X, Y draw a circle with a center at the origin O (0,0) of the coordinate system with the abscissa axis X and the ordinate axis Y shown in FIG. 2. This circle is called an azimuth circle. Here, an angle θ formed by a straight line connecting the origin O (0,0) and a coordinate (X, Y) and the Y-axis is expressed by:
θ=tan⁻¹(X/Y) [Equation 2]

As mentioned above, when there is no influence of magnetization of the mobile object in itself (hereinafter, simply referred to “magnetization”), the plot of the output signals X, Y in a full turn of the mobile object forms a circle with a center at the origin O (0,0), as indicated by the solid line in FIG. 2. Accordingly, if X, Y are obtained, θ, the heading direction of the mobile object can be calculated using Equation 2.

When the mobile object crosses railroad tracks, for instance, the mobile object is magnetized and the azimuth circle is shifted, for instance, in the direction of the arrow and becomes a circle with a center at O_{A} (X_{A}, Y_{A}), as indicated by the dotted line. If the heading direction of the mobile object is calculated on the base of the output signals on the azimuth circle which has been sifted thus greatly, that is, the output signals (Xᵢ, Yᵢ) detected as two perpendicular component data of the Earth's magnetic field vector, large directional errors are measured and an unintelligible direction is suddenly displayed.

To reduce this kind of directional errors caused by magnetization, in some conventional electronic compasses for mobile objects using a magnetic sensor, a perpendicular bisector of a line segment connecting two two-dimensional coordinate data points is calculated and the calculated perpendicular bisector is sequentially stored and classified into a plurality of sectors by its inclination, and when more than a specified number of data are stored in all the sectors, a representative value of each sector is calculated. Then, a point where the sum of squares of distances from the respective representative values is a minimum is calculated and used as a center of the azimuth circle. (For example, see Japanese Unexamined Patent Publication (Koukai) No. H06-58758)

This method takes a long time to display a relatively accurate direction, because this method needs to store more than a specified number of data in all sectors and the center of the azimuth circle is obtained by calculating a point where the sum of squares is a minimum.

In another some electric compasses, a parameter to determine an oval as an azimuth circle is obtained from a predetermined number of two-dimensional coordinate data detected by a geomagnetic direction sensor, using the least square method, and the two-dimensional coordinate data located on the determined oval are converted into data on a true circle and then a center of the azimuth circle is calculated. (For example, see Japanese Unexamined Patent Publication (Koukai) No. H09-68431)

This method also takes a long time to display a relatively accurate direction, since this method needs to wait until a certain number of data are collected in order to obtain a center of the azimuth circle.

When these conventional electronic compasses using a magnetic sensor are magnetized, it takes a lot of time to display a relatively accurate direction, as mentioned above. Therefore, a direction including an enormous error (or an intelligible direction) will be displayed for a long time. Since a driver is generally ignorant of the magnetization, the display of the intelligible direction for a long time makes the driver uneasy.

### SUMMARY OF THE INVENTION

The present invention has been conceived in view of the above problems. It is an object of the present invention to provide an electronic compass and a direction finding method which can free a driver from uneasiness due to display of an intelligible direction.

An electronic compass according to a first aspect of the present invention, which has been conceived to dissolve the above problems, comprises: a geomagnetic direction sensor having two magnetic sensor elements arranged perpendicular to each other for detecting two components of the Earth's magnetic field vector, which varies with a heading direction θ of a mobile object, as two-dimensional Cartesian coordinate data (X₁, Y₁), (X₂, Y₂) . . . (Xᵢ, Yᵢ); a direction calculating means for calculating the heading direction θ of the mobile object from the two-dimensional coordinate data (Xᵢ, Yᵢ); a magnetic field judging means for determining whether the magnetic field is normal or abnormal; and a correcting means for correcting a center of an azimuth circle plotted by the two-dimensional coordinate data (Xᵢ, Yᵢ) in a turn of the mobile object, when the magnetic field judging means determines that the magnetic field is abnormal. The correcting means has the center calculating means for calculating a center of the azimuth circle from at least three of the two-dimensional coordinate data (Xᵢ, Yᵢ); and a least squares calculating means for calculating the azimuth circle from a predetermined number of the two-dimensional coordinates data (Xᵢ, Yᵢ), using the least square method. The direction calculating means outputs the heading direction θ calculated from the two-dimensional coordinate data (Xᵢ, Yᵢ) when the magnetic field judging means determines that the magnetic field is normal, and calculates and outputs the heading direction θ sequentially by using the center of the azimuth circle corrected by the correcting means when the magnetic field judging means determines that the magnetic field is abnormal.

Only when the magnetic field judging means determines that the magnetic field is abnormal and the center of the azimuth circle has to be corrected, a center of the azimuth circle is calculated from at least three two-dimensional coordinate data (Xᵢ, Yᵢ) by the center calculating means, and the direction is obtained by the direction calculating means by using the calculated center as a provisional center of the azimuth circle. Therefore, a relatively accurate direction can be displayed in a short time. At a later time, a center of the azimuth circle is obtained from a predetermined number of the two-dimensional coordinate data by the least squares calculating means and a direction is obtained by the direction calculating means. So, a direction with a higher accuracy can be displayed eventually. Accordingly, display of an intelligible direction due to magnetization can be stopped and the driver can be freed from uneasiness.

In an electronic compass according to the first aspect of the present invention, the magnetic field judging means may determine whether the magnetic field is normal or abnormal by comparing magnitude of the magnetic field vector obtained from the two-dimensional coordinate data (Xᵢ, Yᵢ) and/or a time variation of the heading direction θ calculated by the direction calculating means, with a predetermined threshold value.

Since both magnitude of the magnetic field vector and a time variation of the heading direction θ can be obtained from the two-dimensional coordinate data (Xᵢ, Yᵢ), a new component is not required. Whether the magnetic field is normal or abnormal can be determined by either or both of magnitude of the magnetic vector or a time variation of the heading direction θ. The determination based on the both attains a higher accuracy.

In an electronic compass according to the first aspect of the present invention, the center calculating means may obtain at least two perpendicular bisectors of at least two line segments connecting different two-dimensional coordinate data, from the two-dimensional coordinate data (Xᵢ, Yᵢ), and calculate an intersecting point of the at least two perpendicular bisectors.

Since an intersecting point of respective perpendicular bisectors of two chords connecting three two-dimensional coordinate data is obtained and used as a provisional center of the azimuth circle, display of an intelligible direction due to magnetization can be stopped in a short time.

In this electronic compass, the correcting means may further have an averaging means for averaging the intersecting point calculated by the center calculating means and a center point of the azimuth circle calculated by the least squares calculating means.

Since an average value of the intersecting point calculated by the center calculating means and a center point of the azimuth circle calculated by the least squares calculating means is obtained and a direction is obtained by the direction calculating means by using the average value as a center of the azimuth circle, a direction with a higher accuracy can be displayed eventually.

In an electronic compass according to the first aspect of the present invention, the center calculating means may obtain a triangle connecting three data from the two-dimensional coordinate data (Xᵢ, Yᵢ), and draw a perpendicular defined by a length of a longest side of the triangle and an apex angle opposite the longest side from a midpoint on the longest side, thereby calculating an end point of the perpendicular.

Since a triangle connecting three data is obtained and an end point of a perpendicular drawn from a midpoint on a longest side of the triangle is calculated and used as a provisional center of the azimuth circle, display of an intelligible direction due to magnetization can be stopped in a short time.

In this electronic compass, the correcting means may have an averaging means for averaging the end point calculated by the center calculating means and a center point of the azimuth circle calculated by the least squares calculating means.

Since an average value of the end point calculated by the center calculating means and a center point of the azimuth circle calculated by the least squares calculating means is obtained and a direction is obtained by the direction calculating means by using the average value as a center of the azimuth circle, a direction with a higher accuracy can be displayed eventually.

In an electronic compass according to the first aspect of the present invention, the magnetic sensor elements can be magneto-impedance sensors.

Magneto-impedance sensors are so ultracompact that the geomagnetic direction sensor can be reduced in size. Accordingly, the geomagnetic direction sensor can be installed in a mirror frame or a mounting base of a rearview mirror of a vehicle. Consequently, the geomagnetic direction sensor can be installed at a distance from such steel products having high permeability as roof and other structural body components of a vehicle, which are prone to have harmful influences on magnetic sensors, and an electronic compass with a higher accuracy can be realized.

A direction finding method according to a second aspect of the present invention, which has been conceived to dissolve the above problems, comprises a two-dimensional coordinate data detecting step for detecting two components of the Earth's magnetic field vector, which varies with a heading direction θ of a mobile object, as two-dimensional Cartesian coordinate data (X₁, Y₁), (X₂, Y₂) . . . (Xᵢ, Yᵢ); a direction calculating step for calculating the heading direction θ of the mobile object from the two-dimensional coordinate data (Xᵢ, Yᵢ) detected in the two-dimensional coordinate data detecting step; a magnetic field judging step for determining whether the magnetic field is normal or abnormal; and a correcting step for correcting a center of an azimuth circle plotted by the two-dimensional coordinate data in a turn of the mobile object, when the magnetic field judging step determines that the magnetic field is abnormal. The correcting step has a center calculating step for calculating the center of the azimuth circle from at least three of the two-dimensional coordinate data (Xᵢ, Yᵢ); and a least squares calculating step for calculating the azimuth circle plotted in the turn of the mobile object from a predetermined number of the two-dimensional coordinate data (Xᵢ, Yᵢ), using the least square method. The direction calculating step outputs the heading direction θ of the mobile object calculated from the two-dimensional coordinate data (Xᵢ, Yᵢ) when the magnetic field judging step determines that the magnetic field is normal, and calculates and outputs the heading direction θ sequentially by using the center of the azimuth circle corrected in the correction step when the magnetic field judging step determines that the magnetic field is abnormal.

In a direction finding method according to the second aspect of the present invention, the magnetic field judging step may determine whether the magnetic field is normal or abnormal by comparing magnitude of the magnetic vector obtained from the two-dimensional coordinate data (Xᵢ, Yᵢ) and/or a time variation of the heading direction θ calculated in the direction calculating step, with a predetermined threshold value.

In a direction finding method according to the second aspect of the present invention, the center calculating step may obtain at least two perpendicular bisectors of at least two line segments connecting different two-dimensional coordinate data, from the two-dimensional coordinate data (Xᵢ, Yᵢ), and calculate an intersecting point of the at least two perpendicular bisectors.

In this direction finding method, the correcting step may have an averaging step for averaging the intersecting point calculated in the center calculating step and a center point of the azimuth circle calculated in the least squares calculating step.

In a direction finding method according to the second aspect of the present invention, the center calculating step may obtain a triangle connecting three data from the two-dimensional coordinate data (Xᵢ, Yᵢ), and draw a perpendicular defined by a length of a longest side of the triangle and an apex angle opposite the longest side from a midpoint on the longest side, thereby calculating an end point of the perpendicular.

In this direction finding method, the correcting step may have an averaging step for averaging the end point calculated in the center calculating step and a center point of the azimuth circle calculated in the least squares calculating step.

Owing to the above construction, the electronic compass according to the first aspect of the present invention and the direction finding method according to the second aspect of the present invention have the following advantages.

Even if the electronic compass displays an incorrect direction due to magnetization, immediately the center of the azimuth circle can be corrected by the center calculating means, using a turn of the vehicle, and at a later time the center of the azimuth circle can be corrected with a higher accuracy by the least squares calculating means. Therefore, the present invention allows a vehicle driver to keep comfortable drive, freed from uneasiness due to display of directional errors.

Besides, since an average value of the center position of the azimuth circle calculated by the center calculating means and the center position of the azimuth circle calculated by the least squares calculating means is used as a center of the azimuth circle, correction can be carried out with a much higher accuracy.

### BRIEF DESCRIPTION OF THE DRAWINGS

In describing preferred embodiments of the present invention, reference is made to the accompanying drawings wherein like parts have like reference numerals.

FIG. 1 is a plan view showing a basic principle of an electronic compass.

FIG. 2 is a diagrammatic view showing that an azimuth circle is shifted by a disturbing magnetic field.

FIG. 3 is a block diagram of an electronic compass according to a first preferred embodiment of the present invention.

FIG. 4 is a diagrammatic structural view of a geomagnetic direction sensor using MI sensors.

FIG. 5 is a side view showing that the geomagnetic direction sensor using MI sensors is mounted on a rearview mirror of an automobile.

FIG. 6 is a block diagram of the relevant parts of an electronic compass according to a modified version of the first preferred embodiment.

FIG. 7 is a plan view showing that a vehicle equipped with the electronic compass of the first preferred embodiment turns from going north to going east.

FIG. 8 is an explanatory view illustrating a method of obtaining a center of the azimuth circle from the two-dimensional coordinate data points plotted in the turn shown in FIG. 7, using perpendicular bisectors or the least square method.

FIG. 9 is a block diagram of an electronic compass according to a second preferred embodiment of the present invention.

FIG. 10 is an explanatory view illustrating a method of obtaining a triangle connecting three data points from the two-dimensional coordinate data points in the turn shown in FIG. 7 and obtaining an end point of a perpendicular drawn from a midpoint on a longest side of the triangle.

FIG. 11 is a flowchart of a magnetic field judging means A in the electronic compass according to the first preferred embodiment.

FIG. 12 is a flowchart of a center calculating means A in the electronic compass according to the first preferred embodiment.

FIG. 13 is a flowchart of a least squares calculating means in the electronic compass according to the first preferred embodiment.

FIG. 14 is a flowchart of an averaging means in the electronic compass according to the modified version of the first preferred embodiment.

FIG. 15 is a flowchart of a magnetic field judging means B in the electronic compass according to the second preferred embodiment.

FIG. 16 is a flowchart of a center calculating means B in the electronic compass according to the second preferred embodiment.

### DESCRIPTION OF THE PREFERRED EMBODIMENTS

Now, preferred embodiments of the present invention will be described with reference to the drawings.

### First Preferred Embodiment

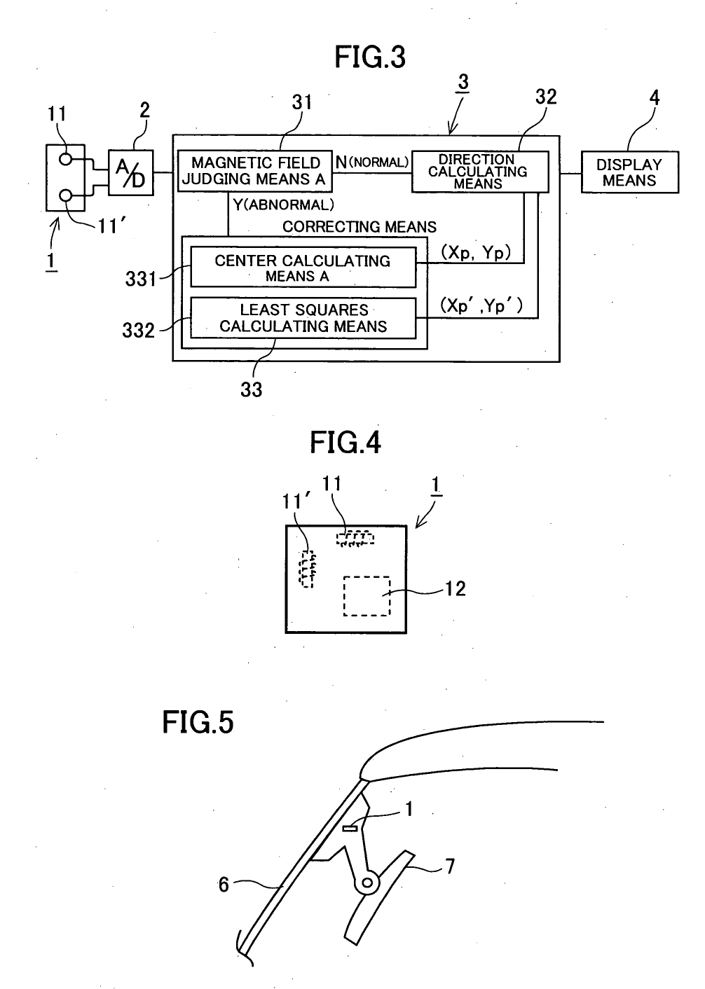

An electronic compass of this preferred embodiment comprises, as shown in FIG. 3, a geomagnetic direction sensor 1 having a pair of magnetic sensor elements 11, 11′ which are sensor bars arranged perpendicular to each other and detect an X component and a Y component of the Earth's magnetic field vector as two-dimensional Cartesian coordinate data (X₁, Y₁), (X₂, Y₂) . . . (Xᵢ, Yᵢ); an A/D converter which converts outputs from the magnetic sensor elements 11, 11′ into digital signals at a predetermined period frequency; a microcomputer 3 which calculates a heading direction of a mobile object from the inputted digital signals in software; and a display means 4 for displaying the calculated direction.

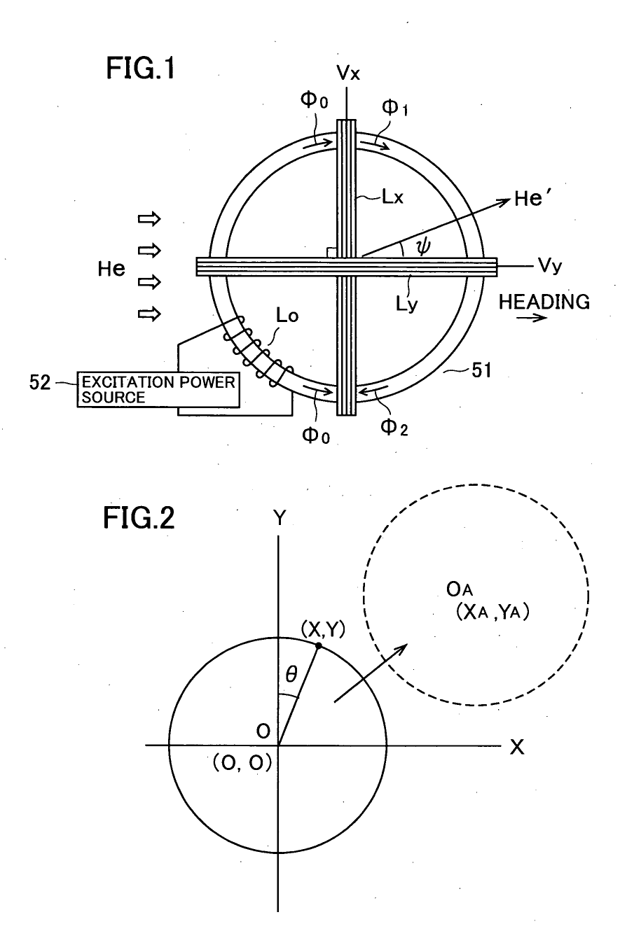

It is possible to employ, as the geomagnetic direction sensor 1, the conventional sensor which uses two coils wound orthogonally around a permalloy core as the magnetic sensor elements 11, 11′, as shown in FIG. 1. However, it is preferable to employ a magnetic sensor which uses magneto-impedance sensors as the magnetic sensor elements 11, 11′. The magneto-impedance sensor (hereinafter referred to as an MI sensor) is an ultracompact, high-sensitive magnetic sensor, which comprises, for instance, an amorphous FeCoSiB wire of 20 μm in diameter and 1 mm in length and a pickup coil wrapped around this amorphous wire and outputs an analogue voltage in proportion with strength of the magnetic field. In this case, as shown in FIG. 4, the geomagnetic direction sensor 1 can be an IC package of about 3.5 mm in square including two orthogonally arranged MI sensors 11, 11′ and a driving circuit 12. When the mobile object is an automobile, since the geomagnetic direction sensor 1 is as ultracompact as 3.5 mm square, the geomagnetic direction sensor 1 can be attached, for instance, to a mounting base of a rearview mirror 7, which is installed on a windshield 6, as shown in FIG. 5.

The A/D converter 2 preferably has a resolution of about 14 bits. In this case, the mobile object can attain enough heading direction resolution and at the same time signals will never be saturated even when strength of peripheral magnetic fields of the geomagnetic direction sensor 1 becomes greater than the Earth's magnetic field due to magnetization of the mobile object.

The microcomputer 3 comprises a magnetic field judging means A 31 for determining whether the magnetic field is normal or abnormal, a direction calculating means 32 for calculating a heading direction θ of the mobile object, and a correcting means 33 for correcting a center of an azimuth circle when the magnetic field judging means A 31 determines that the magnetic field is abnormal. The correcting means 33 has a center calculating means A 331 and a least squares calculating means 332. It is to be noted that the magnetic field judging means A 31, the direction calculating means 32 and the correcting means 33 are software components.

The magnetic field judging means A 31 is to determine whether the magnetic field is normal or abnormal by comparing magnitude of the magnetic field vector obtained from the two-dimensional coordinate data (Xᵢ, Yᵢ) with a predetermined threshold value.

The center calculating means A 331 is to obtain two perpendicular bisectors of two line segments between different two-dimensional coordinate data, from the two-dimensional coordinate data (Xᵢ, Yᵢ), calculate an intersecting point of the two perpendicular bisectors and use the intersecting point as a center. However, it is preferable to obtain three or more perpendicular bisectors of three or more line segments between different two-dimensional coordinate data, from the two-dimensional coordinate data (Xᵢ, Yᵢ) and average their intersecting points. In this case, the intersecting point can be obtained with a higher accuracy and the heading direction can be measured with a higher accuracy.

The two-dimensional coordinate data (Xᵢ, Yᵢ) from the two magnetic sensor elements 11, 11′ are inputted into the microcomputer 3 through the A/D converter 2. The magnetic field judging means A 31 of the microcomputer 3 determines which of an absolute value (Xᵢ²+Yᵢ²)^{1/2} of the two-dimensional coordinate data (Xᵢ, Yᵢ) and Ha±Hs is greater. Here, Ha is an absolute value of the horizontal components of the Earth's magnetic field in Honshu, the main island of Japan and Ha=300 mGs (=30 μT), and Hs is set in the range from one-tenth to two-tenths of Ha and, for instance, Hs=50 mGs (=5 μT). Desirably, Ha and Hs are varied in accordance with a region in which the electronic compass is used. Hs can have different values between on the positive side and on the negative side, for example, +Hs and −Hs′.

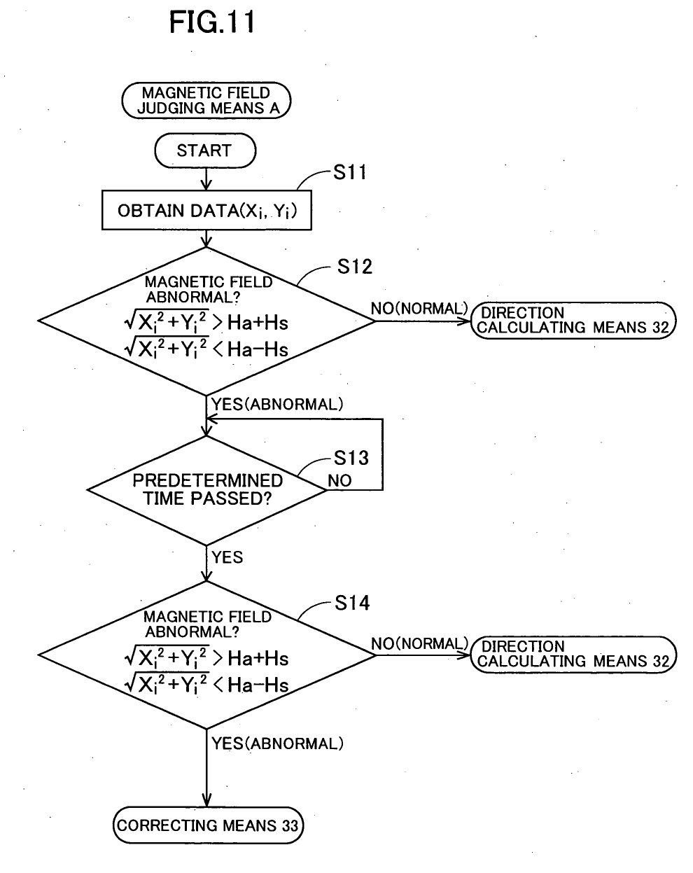

The operation of the magnetic field judging means A 31 will be described with reference to the flowchart of FIG. 11. In step 11, two-dimensional coordinate data (Xᵢ, Yᵢ) are obtained. In step 12, (Xᵢ²+Yᵢ²)^{1/2} is calculated and compared with Ha±Hs. When either of (Xᵢ²+Yᵢ²)^{1/2}>Ha+Hs and (Xᵢ²+Yᵢ²)^{1/2}<Ha−Hs is true, the magnetic field is determined to be abnormal. When either of them is not true, that is, Ha−Hs≦(Xᵢ²+Yᵢ²)^{1/2}≦Ha+Hs, the magnetic field is determined to be normal. When the magnetic field is determined to be abnormal, the microcomputer 3 proceeds to step 13, where whether a predetermined time has passed or not is determined. In step 14, whether either of (Xᵢ²+Yᵢ²)^{1/2}>Ha+Hs and (Xᵢ²+Yᵢ²)^{1/2}<Ha−Hs is true or not is determined again in order to determine whether the magnetic field is abnormal or not. When the magnetic field is determined to be abnormal again in step 14, the microcomputer 3 proceeds to the correction means 33.

When the magnetic field is determined to be normal in step 12 or step 14, the microcomputer 3 proceeds to the direction calculating means 32, where θ is calculated using the aforementioned Equation 2 and the heading direction is informed to a vehicle driver by the display means 4.

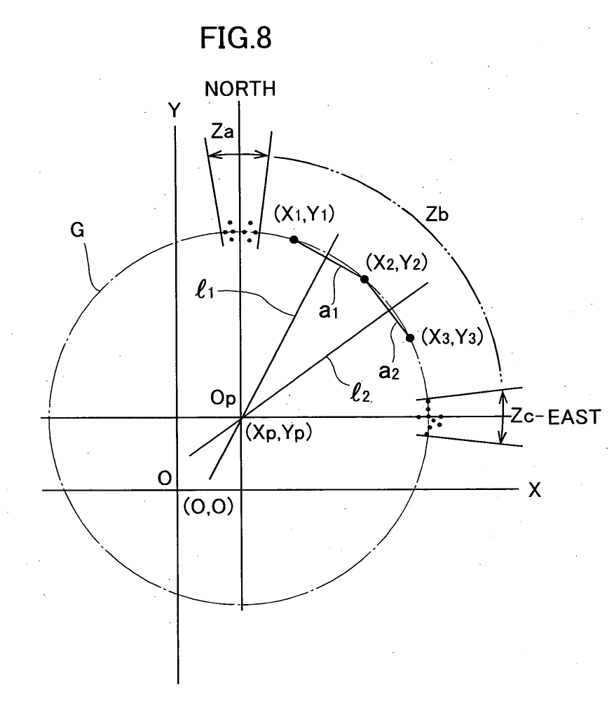

As mentioned above, when the magnetic field is determined to be abnormal again in step 14, the microcomputer 3 proceeds to the correction means 33, where the center of the azimuth circle is corrected as follows. For example, as shown in FIG. 7, when a mobile object goes north in the zone Za, makes a 90-degree turn in the zone Zb, and goes east in the zone Zc, the two-dimensional coordinate data points (Xᵢ, Yᵢ) are distributed around the azimuth circle as shown in FIG. 8. That is to say, in the zone Za, which is a straight road before a curve, and in the zone Zc, which is a straight road after the curve, the mobile object goes almost straight, although the mobile object makes slightly wobbly movements. Therefore, the data points gather in a large number at positions indicating approximately the same heading direction. In the curved zone Zb, the distances between data points are greater. Besides, since there are noises in the electric circuit including the geomagnetic sensor elements 11, 11′ due to pitch and roll of the vehicle, the two-dimensional coordinate data (Xᵢ, Yᵢ) do not necessarily lie on an ideal azimuth circle G and are distributed in the periphery of the ideal azimuth circle G. The center calculating means A 331 calculates, as a center position of the azimuth circle, an intersecting point (Xₚ, Yₚ) of two perpendicular bisectors l₁, l₂ of two chords a₁, a₂ of three data points (X₁, Y₁), (X₂, Y₂), (X₃, Y₃) obtained in the turn of the vehicle. The calculated center position (Xₚ, Yₚ) of the azimuth circle is used by the direction calculating means 32, as shown in FIG. 3. That is, θ is calculated using Equation 3.
θ=tan⁻¹[(Xᵢ−Xₚ)/(Yᵢ−Yₚ)] [Equation 3]

Then the heading direction is informed to a vehicle driver by the display means 4.

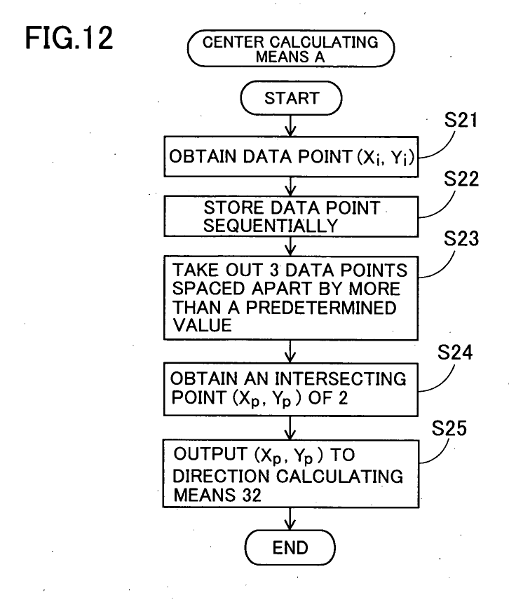

The operation of the center calculating means A 331 is carried out by software, as shown in the flowchart of FIG. 12. This flowchart starts when the magnetic field judging means A 31 determines that the magnetic field is abnormal. In step 21, a data point (Xᵢ, Yᵢ) is obtained. In step 22, the data point is sequentially stored. Next, in step 23, three data points spaced apart by more than a predetermined value are taken out. Here, “data points spaced apart by more than a predetermined value” are, for example, two data points (Xᵢ, Yᵢ), (Xⱼ, Yⱼ) having a distance [(Xᵢ−Xⱼ)²+(Yᵢ−Yⱼ)²]^{1/2} which is greater than a predetermined value L. Here, “a predetermined value L” is, for instance, 0.5 when the above azimuth circle has a radius of 1. When data points spaced apart by more than a predetermined value L are taken out in step 23, an intersecting point (Xₚ, Yₚ) of respective perpendicular bisectors of two chords connecting the respective data points in step 24, and the calculation result is outputted to the direction calculating means 32 in step 25.

This method of calculating a center of the azimuth circle by using perpendicular bisectors is characterized in that only three data points in a turn of a vehicle allows immediate calculation of a center of the azimuth circle and that a provisional heading direction can be informed to the driver. It is true that this method using momentarily changing data of the geomagnetic direction sensor 1 tends to have errors, because in the actual use respective data points do not always lie on an ideal azimuth circle, as mentioned above. However, this method allows a quick recovery from such a situation as the vehicle is magnetized and an unintelligible direction is suddenly displayed. Therefore, this method is useful and practical enough as a correcting means to protect a driver from uneasiness. Especially in the case of electronic compasses for vehicles, because displays are often demanded to have a resolution of about 8 directions or 16 directions, it is judged that this method exhibits sufficient performance.

Next, in the zone Zc after the turn of the vehicle as well as in the zone Za before the turn of the vehicle as shown in FIG. 8, since a lot of data points are obtained, the least squares calculating means 332 can estimate a sufficiently accurate azimuth circle by using a predetermined number of data points and calculate its center position with a sufficient precision.

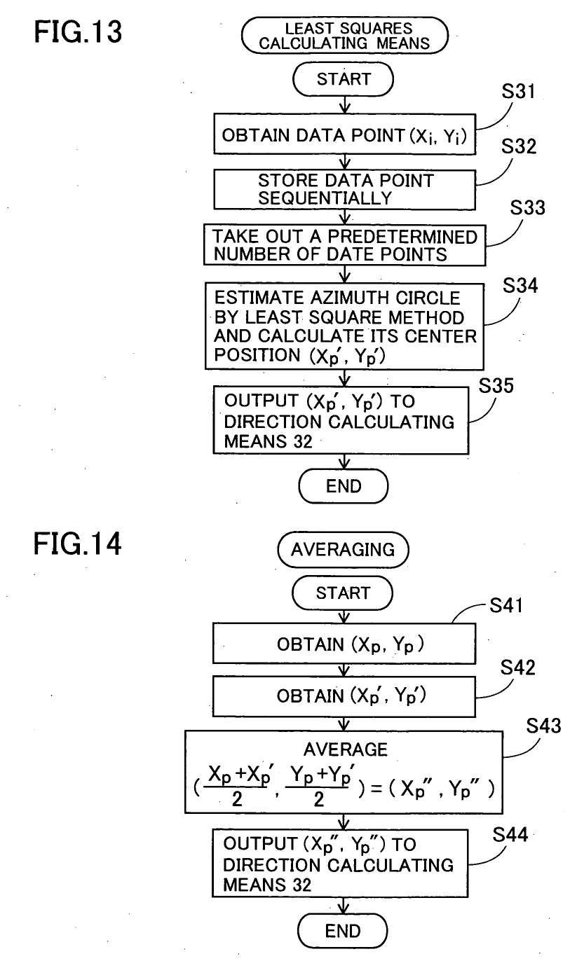

The operation of the least squares calculating means 332 is carried out by software, as shown in the flowchart of FIG. 13. This flowchart starts at the same time as the center calculating means A 331, when the magnetic field judging means A 31 determines that the magnetic field is abnormal. In step 31, a data point is obtained. In step 32, the data point is sequentially stored. Next, in step 33, a predetermined number of data points are taken out. In step 34, an azimuth circle is estimated by the least square method, and a center position (Xₚ′, Yₚ′) of this azimuth circle is calculated. Here, “a predetermined number of data points” to be taken out is 40. The calculated center position (Xₚ′, Yₚ′) is outputted to the direction calculating means 32 in step 35. In FIG. 8, the distances between data points in the zone Za and in the zone Zc are smaller than those of the zone Zb, and a large number of data points gather as a data group. Therefore, it is preferable to average the data points in each group in the zone Za and in the zone Zc beforehand and replace these data points as one data point and then find least squares estimates to the data points in the respective zones Za, Zb and Zc. Uniform density of data points in each part of the curve allows a more accurate approximation.

This calculation of the center position (Xₚ′, Yₚ′) by the least squares calculating means 332 needs a certain time to collect a predetermined number of data points and is completed at a later time than the center calculating means A 331. As shown in FIG. 3, upon receiving the center position data (Xₚ′, Yₚ′) from the least squares calculating means 332, the direction calculating means 32 replaces the provisional data with the received data and calculates a new heading direction θ by using the received data as a center position of a new azimuth circle, and then the heading direction with a high precision is informed to a driver by the display means 4.

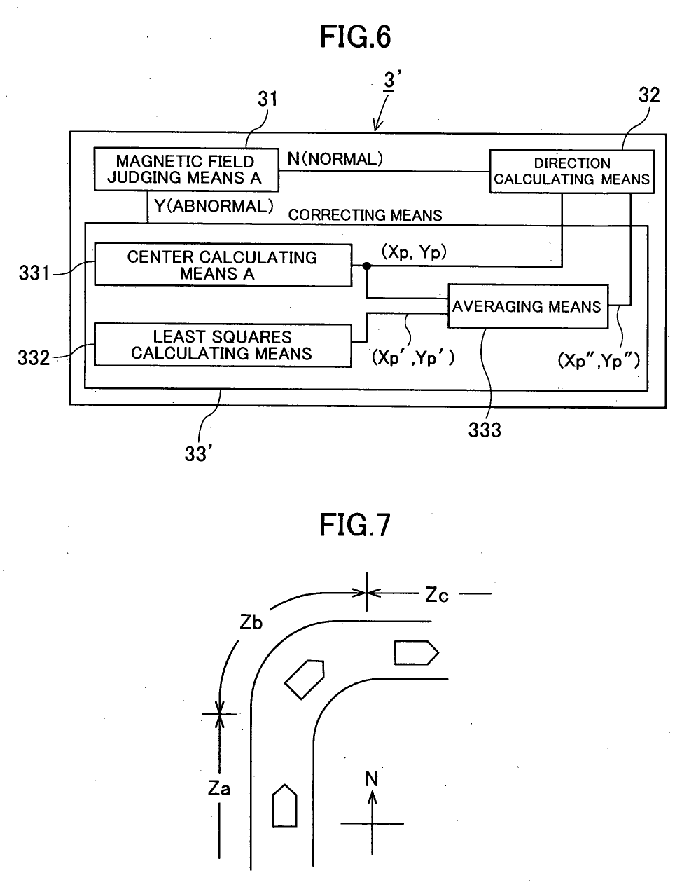

It is preferable that, as shown in FIG. 6, the correcting means 33′ further has an averaging means 333 for averaging the center position (Xₚ, Yₚ) of the azimuth circle obtained by the center calculating means A 331 and the center position (Xₚ′, Yₚ′) of the azimuth circle obtained by the least squares calculating means 332.

When the magnetic field judging means A 31 determines that the magnetic field is abnormal, as shown in FIG. 6, first the center position (Xₚ, Yₚ) of the azimuth circle calculated by the center calculating means A 331 is outputted to the direction calculating means 32 and later, when a predetermined number of data points are collected and calculation of a center position (Xₚ′, Yₚ′) of the azimuth circle by the least squares calculating means 332 is completed, an average of the data points (Xₚ, Yₚ) and (Xₚ′, Yₚ′), that is, ((1−α)Xₚ+αXₚ′, (1−α)Yₚ+αYₚ′) is outputted to the direction calculating means 32 and this average is used as a center position of a new azimuth circle to calculate the heading direction. Here, α is a weight in weighted average and can be 0≦α≦1. In this preferred embodiment, α=0.5, for instance.

The operation of the averaging means 333 is carried out by software, as shown in the flowchart of FIG. 14. In step 41, the center position (Xₚ, Yₚ) of the azimuth circle obtained by the center calculating means A 331 is obtained. In step 42, the center position (Xₚ′, Yₚ′) of the azimuth circle obtained by the least squares calculating means 332 is obtained. In step 43, these two values are averaged. In step 44, the average ((1−α)Xₚ+αXₚ′, (1−α) Yₚ+αYₚ′) is outputted to the direction calculating means 32 as a center position (Xₚ″, Yₚ″) of a new azimuth circle.

Upon receiving the center position data (Xₚ″, Yₚ″) from the averaging means 333, as shown in FIG. 6, the direction calculating means 32 replaces the provisional data with this data as a center position of a new azimuth circle and calculates a new heading direction θ, and then informs a driver of the heading direction with a higher precision by the display means 4.

### Second Preferred Embodiment

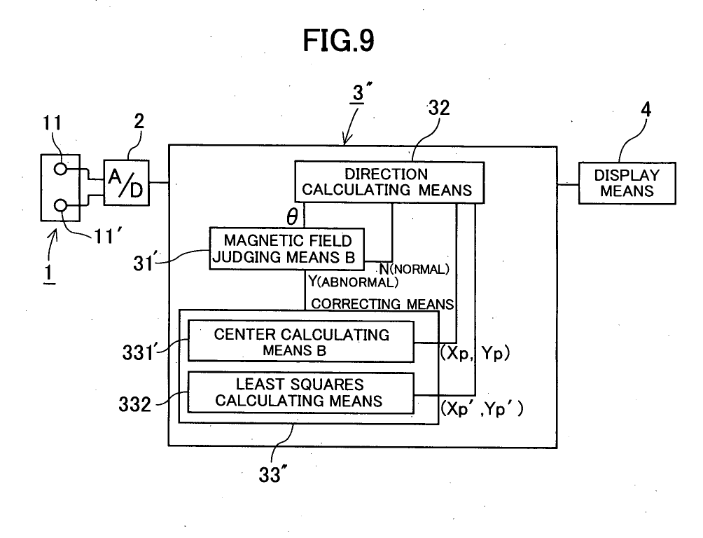

An electronic compass of this preferred embodiment is similar to that of the first preferred embodiment, except for the microcomputer, as shown in FIG. 9. A microcomputer 3″ of this preferred embodiment comprises a direction calculating means 32 for calculating a heading direction θ of a mobile object, a magnetic field judging means B 31′ for receiving the heading direction θ from the direction calculating means 32 and determining whether the magnetic field is normal or abnormal, and a correcting means 33″ for correcting the center of the azimuth circle when the magnetic field judging means B 31′ determines that the magnetic field is abnormal. The correcting means 33″ has a center calculating means B 331′ and a least squares calculating means 332. It is to be noted that the magnetic field judging means B 31′, the direction calculating means 32 and the correcting means 33″ are software components. The same components as those of the first preferred embodiment are designated by the same numerals and their description is omitted.

The magnetic field judging means B 31′ calculates an angular velocity δθ/δt by differentiating with respect to time the directions θ received from the direction calculating means 32 and compares the calculated angular velocity δθ/δt with a predetermined angular velocity k. The predetermined angular velocity k is a larger angular velocity than those which can be generated by a turn of the vehicle and, for instance, k=90°/sec.

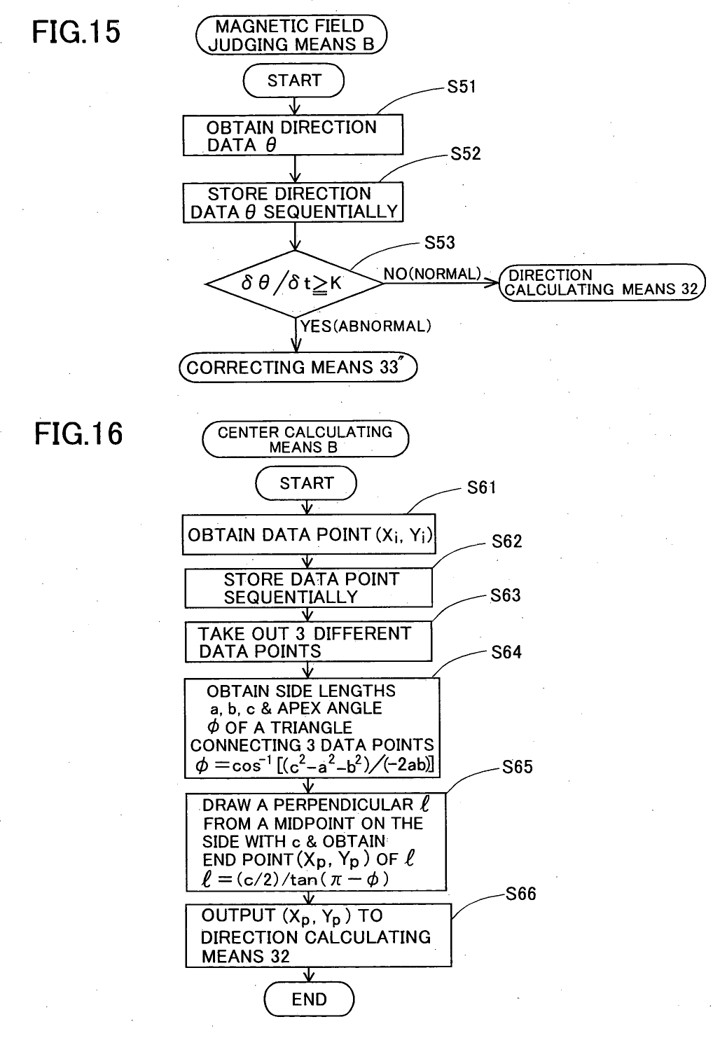

The operation of the magnetic field judging means B 31′ will be described with reference to the flowchart of FIG. 15. In step 51, a piece of direction data θ is obtained. In step 52, this data is sequentially stored. Next, in step 53, δθ/δt is calculated and whether δθ/δt≧k or not is determined. When this is not true, that is, δθ/δt<k, the magnetic field is determined to be normal. When δθ/δt≧k is true, the magnetic field is determined to be abnormal. When the magnetic field is determined to be abnormal in step 53, the microcomputer 3″ proceeds to the correcting means 33″. When the magnetic field is determined to be normal in step 53, the microcomputer 3″ orders the direction calculating means 32 to output the calculated direction to the display means 4.

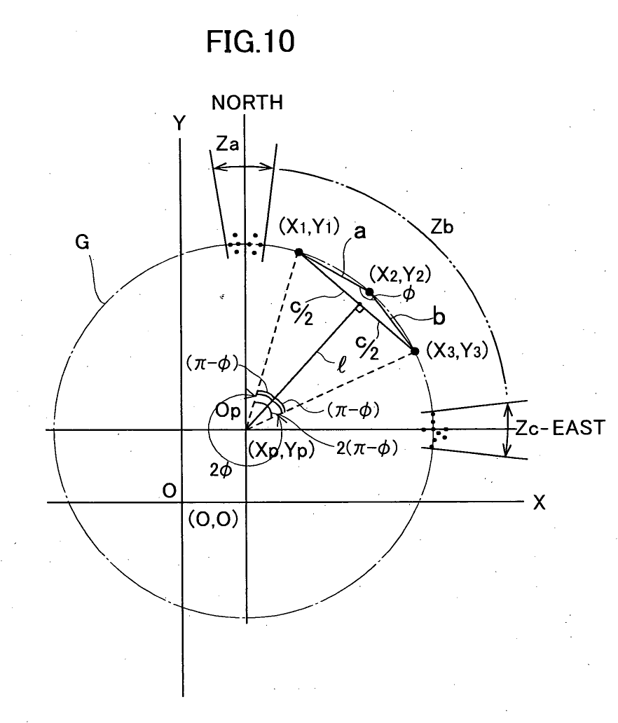

As mentioned before, when the magnetic field is determined to be abnormal in step 53, the microcomputer 3″ proceeds to the correcting means 33″, where the center of the azimuth circle is corrected as follows. While the center calculating means A 331 of the first preferred embodiment obtains an intersecting point of two perpendicular bisectors, as shown in FIG. 10, the center calculating means B 331′ of this preferred embodiment draws a perpendicular l expressed by the following Equation 4 from a midpoint on a longest side of a triangle connecting three data points (X₁, Y₁), (X₂, Y₂), (X₃, Y₃), and calculates an end point (Xₚ, Yₚ) of the perpendicular l and uses the end point (Xₚ, Yₚ) as a center position of the azimuth circle.
l=(c/2)/tan(π−φ) [Equation 4]

Equation 4 is derived as follows. From the cosine law, we have
φ=cos⁻¹[(c²−a²−b²)/(−2ab)] [Equation 5]

where, as shown in FIG. 10, a is the length of the side (X₁, Y₁), (X₂, Y₂), b is the length of the side (X₂, Y₂), (X₃, Y₃) and c is the length of the side (X₃, Y₃), (X₁, Y₁), and φ is ∠(X₁, Y₁), (X₂, Y₂), (X₃, Y₃).

On the other hand, since an exterior angle at a vertex Oₚ of a triangle connecting two points (X₁, Y₁) (X₃, Y₃) of a triangle (X₁, Y₁), (X₂, Y₂), (X₃; Y₃) inscribed in a circle G and the center Oₚ of the circle G, namely, an exterior angle of ∠(X₁, Y₁), Oₚ, (X₃, Y₃) is geometrically 2φ, an interior angle at the vertex Oₚ, namely, ∠(X₁, Y₁), Oₚ, (X₃, Y₃) is 2(π−φ). Each apex angle of two triangles whose sides are a perpendicular l dropped from the center Oₚ to the side having the length c is (π−φ). Accordingly, we have
tan(π−φ)=(c/2)/l
Equation 4 is derived from this equation.

The center position (Xₚ, Yₚ) of the azimuth circle calculated by the center calculating means B 331′ is used by the direction calculating means 32, as shown in FIG. 9, and θ is calculated using Equation 3 and the heading direction is informed to a vehicle driver by the display means 4.

The operation of the center calculating means B 331′ is carried out by software, as shown in the flowchart of FIG. 16. This flowchart starts when the magnetic field judging means B 31′ determines that the magnetic field is abnormal. In step 61, a data point (Xᵢ, Yᵢ) is obtained. In step 62, the data point is sequentially stored. Next, in step 63, three different data points are taken out. In step 64, side lengths a, b, c of a triangle connecting these three data points are obtained and an apex angle φ is calculated using Equation 5. Next, in step 65, a perpendicular l expressed by Equation 4 is drawn from a midpoint on the side having the length c, and an end point (Xₚ, Yₚ) of the perpendicular l is calculated. In step 66, the calculated end point is outputted to the direction calculating means 32.

This method of calculating a center of the azimuth circle by drawing a perpendicular from a midpoint on a side having a length c of a triangle also allows immediate calculation of a center of an azimuth circle if there are only three data points in a turn of the vehicle and can inform a provisional heading direction to a vehicle driver.

Changes and modifications in the specifically described embodiments can be carried out without departing from the principles of the invention, which is intended to be limited only by the scope of the appended claims, as interpreted according to the principles of patent law.

What is claimed is:

1. An electronic compass, comprising:
a geomagnetic direction sensor having two magnetic sensor elements arranged perpendicular to each other for detecting two components of the Earth's magnetic field vector, which varies with a heading direction θ of a mobile object, as two-dimensional Cartesian coordinate data (X₁, Y₁), (X₂, Y₂) . . . (Xᵢ, Yᵢ);
a direction calculating means for calculating said heading direction θ of said mobile object from said two-dimensional coordinate data (Xᵢ, Yᵢ);
a magnetic field judging means for determining whether the magnetic field is normal or abnormal; and
a correcting means for correcting a center of an azimuth circle plotted by said two-dimensional coordinate data (Xᵢ, Yᵢ) in a turn of said mobile object, when said magnetic field judging means determines that the magnetic field is abnormal,
said correcting means having:
a center calculating means for calculating said center of said azimuth circle from at least three of said two-dimensional coordinate data (Xᵢ, Yᵢ); and
a least squares calculating means for calculating said azimuth circle from a predetermined number of said two-dimensional coordinates data (Xᵢ, Yᵢ), using the least square method,
said direction calculating means outputting said heading direction θ calculated from said two-dimensional coordinate data (Xᵢ, Yᵢ) when said magnetic field judging means determines that the magnetic field is normal, and calculating and outputting said heading direction θ sequentially by using said center of said azimuth circle corrected by said correcting means when said magnetic field judging means determines that the magnetic field is abnormal.

2. An electronic compass according to claim 1, wherein said magnetic field judging means determines whether the magnetic field is normal or abnormal by comparing magnitude of said magnetic field vector obtained from said two-dimensional coordinate data (Xᵢ, Yᵢ) and/or a time variation of said heading direction θ calculated by said direction calculating means, with a predetermined threshold value.

3. An electronic compass according to claim 1, wherein said center calculating means obtains at least two perpendicular bisectors of at least two line segments connecting between different two-dimensional coordinate data, from said two-dimensional coordinate data (Xᵢ, Yᵢ), and calculates an intersecting point of said at least two perpendicular bisectors.

4. An electronic compass according to claim 3, wherein said correcting means has an averaging means for averaging said intersecting point calculated by said center calculating means and a center point of said azimuth circle calculated by said least squares calculating means.

5. An electronic compass according to claim 1, wherein said center calculating means obtains a triangle connecting three data from said two-dimensional coordinate data (Xᵢ, Yᵢ), and draws a perpendicular defined by a length of a longest side of said triangle and an apex angle opposite said longest side from a midpoint on said longest side, thereby calculating an end point of said perpendicular.

6. An electronic compass according to claim 5, wherein said correcting means has an averaging means for averaging said end point calculated by said center calculating means and a center point of said azimuth circle calculated by said least squares calculating means.

7. An electronic compass according to claim 1, wherein said magnetic sensor elements are magneto-impedance sensors.

8. A direction finding method, comprising:
a two-dimensional coordinate data detecting step for detecting two components of the Earth's magnetic field vector, which varies with a heading direction θ of a mobile object, as two-dimensional Cartesian coordinate data (X₁, Y₁), (X₂, Y₂) . . . (Xᵢ, Yᵢ);
a direction calculating step for calculating said heading direction θ of said mobile object from said two-dimensional coordinate data (Xᵢ, Yᵢ) detected in said two-dimensional coordinate data detecting step;
a magnetic field judging step for determining whether the magnetic field is normal or abnormal; and
a correcting step for correcting a center of an azimuth circle plotted by said two-dimensional coordinate data in a turn of said mobile object, when said magnetic field judging step determines that the magnetic field is abnormal,
said correcting step having:
a center calculating step for calculating said center of said azimuth circle from at least three of said two-dimensional coordinate data (Xᵢ, Yᵢ); and
a least squares calculating step for calculating said azimuth circle plotted in said turn of said mobile object from a predetermined number of said two-dimensional coordinate data (Xᵢ, Yᵢ), using the least square method,
said direction calculating step outputting said heading direction θ of said mobile object calculated from said two-dimensional coordinate data (Xᵢ, Yᵢ) when said magnetic field judging step determines that the magnetic field is normal, and calculating and outputting said heading direction θ sequentially by using said center of said azimuth circle corrected in said correction step when said magnetic field judging step determines that the magnetic field is abnormal.

9. A direction finding method according to claim 8, wherein said magnetic field judging step determines whether the magnetic field is normal or abnormal by comparing magnitude of said magnetic vector obtained from said two-dimensional coordinate data (Xᵢ, Yᵢ) and/or a time variation of said heading direction θ calculated in said direction calculating step, with a predetermined threshold value.

10. A direction finding method according to claim 8, wherein said center calculating step obtains at least two perpendicular bisectors of at least two line segments connecting between different two-dimensional coordinate data, from said two-dimensional coordinate data (Xᵢ, Yᵢ), and calculating an intersecting point of said at least two perpendicular bisectors.

11. A direction finding method according to claim 10, wherein said correcting step has an averaging step for averaging said intersecting point calculated in said center calculating step and a center point of said azimuth circle calculated in said least squares calculating step.

12. A direction finding method according to claim 8, wherein said center calculating step obtains a triangle connecting three data from said two-dimensional coordinate data (Xᵢ, Yᵢ), and draws a perpendicular defined by a length of a longest side of said triangle and an apex angle opposite said longest side from a midpoint on said longest side, thereby calculating an end point of said perpendicular.

13. A direction finding method according to claim 12, wherein said correcting step has an averaging step for averaging said end point calculated in said center calculating step and a center point of said azimuth circle calculated in said least squares calculating step.
